(19) United States
(12) Patent Application Publication
(10) Pub. No.: US 2005/0081679 A1
(43) Pub. Date: Apr. 21, 2005

(54) Bicycle pedal assembly with a cleat

(76) Inventor: Chung-I Chen, Taichung Hsien (TW)

Correspondence Address: LADAS & PARRY LLP, 224 SOUTH MICHIGAN AVENUE, SUITE 1200, CHICAGO, IL, 60604, US

(21) Appl. No.: 10/685,086

(22) Filed: Oct. 16, 2003

(51) Int. Cl. G05G 1/14

(52) U.S. Cl. 74/594.6

(57) ABSTRACT

A bicycle pedal assembly includes a cleat, a rear cleat-retaining member connected pivotally to a pedal body, and a front cleat-retaining member with a curved front cleat-limiting surface and two inclined cleat-guiding surfaces. A front end engaging portion of the cleat has a narrow upper portion abutting against the front cleat-limiting surface, and a wide lower portion with two inclined side surfaces abutting respectively against the inclined cleat-guiding surfaces. The cleat is swingable forcibly on the front cleat-retaining member to move the inclined side surfaces of the cleat on the inclined cleat-guiding surfaces so as to permit removal of the cleat from the front and rear cleat-retaining members.

### BACKGROUND OF THE INVENTION

1. Field of the Invention

This invention relates to a bicycle pedal assembly, and more particularly to a bicycle pedal assembly that includes a cleat, which is retained between a pair of front and rear cleat-retaining members.

2. Description of the Related Art

A pedal assembly for racing bicycles or mountaineering bicycles normally includes a cleat secured to a cyclist's shoe, a pedal shaft, a shaft tube sleeved rotatably on the pedal shaft, a pedal body, and two cleat-retaining mechanisms that are disposed on two opposite sides of the pedal body. Each of the cleat-retaining mechanisms consists of front and rear cleat-retaining members for retaining the cleat therebetween. However, the conventional pedal assembly has a drawback that it is difficult to remove the cleat from the pedal body.

### SUMMARY OF THE INVENTION

It is the object of this invention to provide a bicycle pedal assembly that includes a cleat, which can be removed easily from a cleat-retaining mechanism.

According to this invention, a bicycle pedal assembly includes a cleat, a rear cleat-retaining member connected pivotally to a pedal body, and a front cleat-retaining member with a limiting groove, a curved front cleat-limiting surface, and two inclined cleat-guiding surfaces. A front end engaging portion of the cleat has a narrow upper portion abutting against the front cleat-limiting surface, and a wide lower portion that has a front end inserted into the limiting groove, and two inclined side surfaces abutting respectively against the inclined cleat-guiding surfaces. The cleat is swingable forcibly on the front cleat-retaining member so as to move the inclined side surfaces of the cleat on the inclined cleat-guiding surfaces, thereby permitting removal of the cleat from the front and rear cleat-retaining members.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic side view of the preferred embodiment of a bicycle pedal assembly according to this invention, which is attached to a cyclist's shoe;

FIG. 2 is a top view of the preferred embodiment, illustrating how a cleat is retained between front and rear cleat-retaining members;

FIG. 3 is a cross-sectional view of the preferred embodiment;

FIG. 4 is a fragmentary assembled perspective view of the preferred embodiment, in which a cleat is removed for the sake of brevity;

FIG. 5 is a fragmentary partly exploded perspective view of the preferred embodiment, in which the cleat is removed for the sake of brevity;

FIG. 6 is a fragmentary side view of the preferred embodiment;

FIG. 7 is a fragmentary front view of the preferred embodiment;

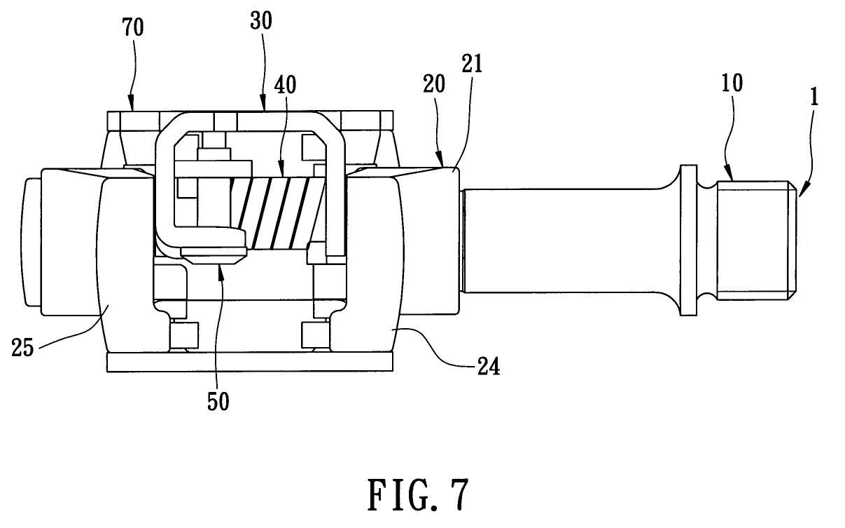

FIG. 8 is a top view of a pedal body of the preferred embodiment; and

FIG. 9 is a fragmentary sectional view of the preferred embodiment taken along line 9-9 in FIG. 8.

### DETAILED DESCRIPTION OF THE PREFERRED EMBODIMENT

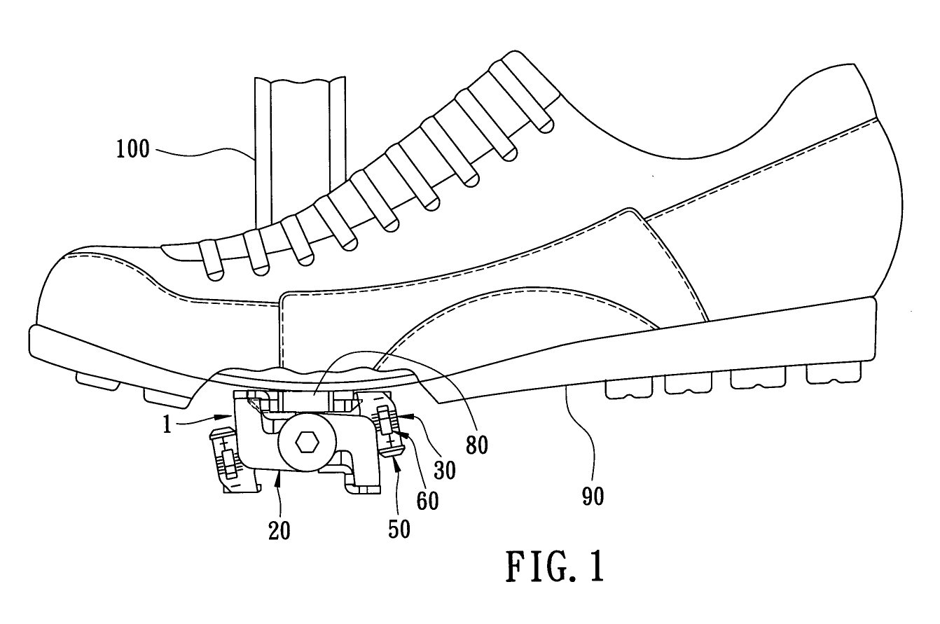

Referring to FIGS. 1, 2, 3, 4, and 5, the preferred embodiment of a bicycle pedal assembly 1 according to this invention is shown to include a pedal shaft 10, a pedal body 20, a cleat 80, and two cleat-retaining mechanisms disposed respectively on two opposite sides of the pedal body 20. When the bicycle pedal assembly 1 is in use, as shown in FIG. 1, the cleat-retaining mechanisms are disposed one above the other. Hereinafter, only the upper cleat-retaining mechanism will be described because the lower cleat-retaining mechanism does not engage the cyclist's shoe 90 during use.

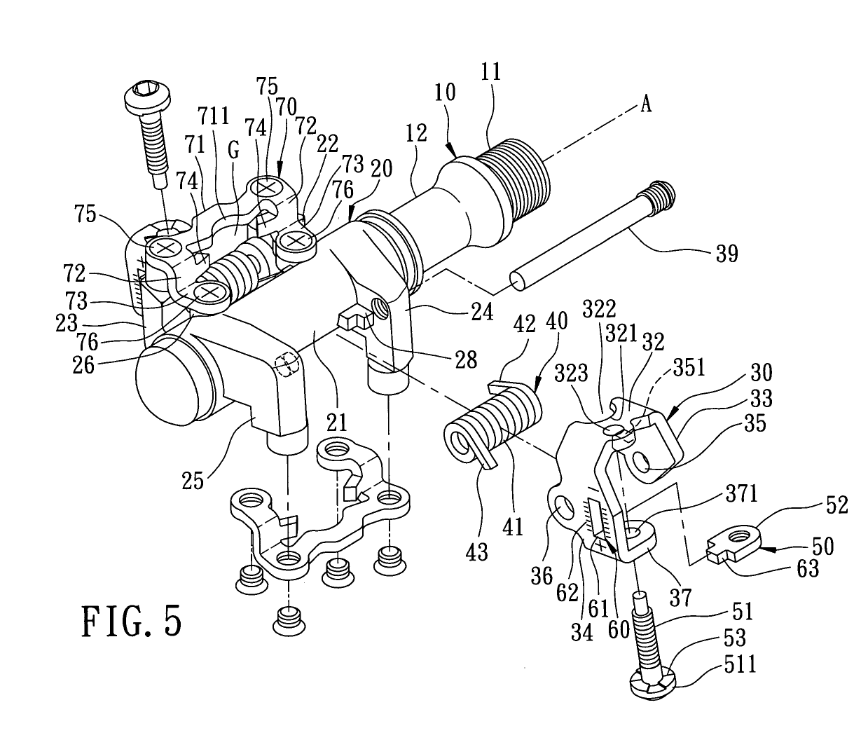

The pedal shaft 10 is connected to a crank 100 (see FIG. 1) in a known manner, and has an inner end 11, an outer end 12, and a central axis (A) (see FIG. 5).

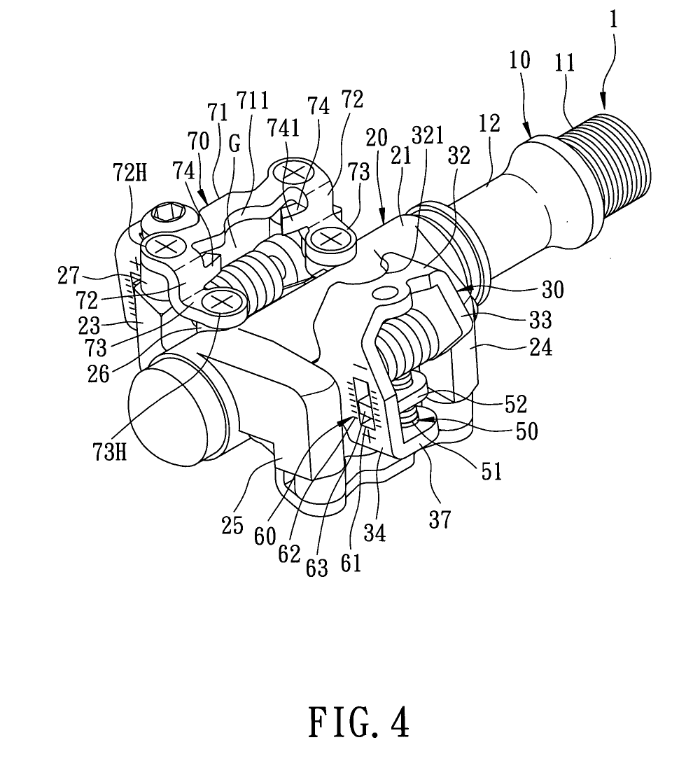

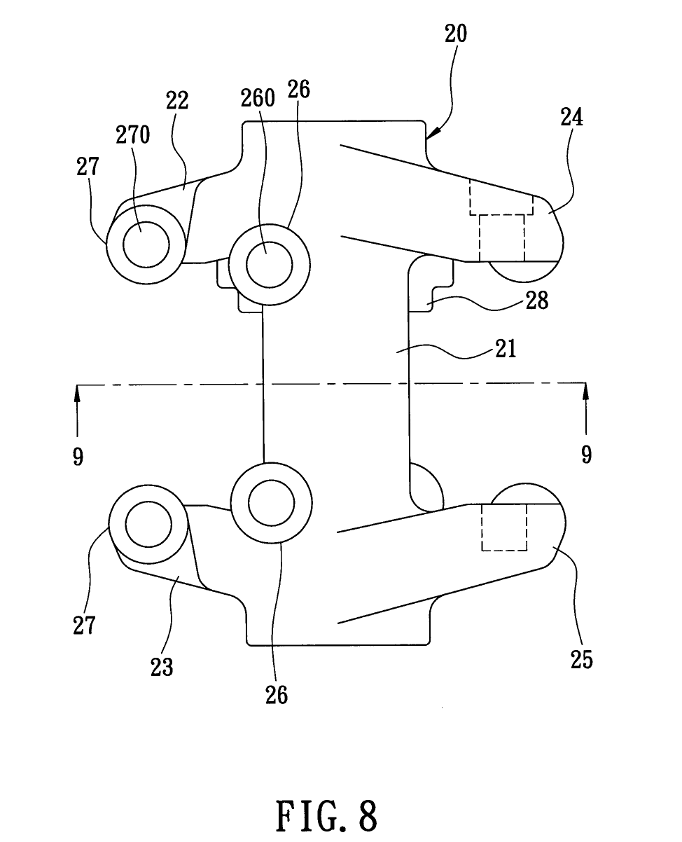

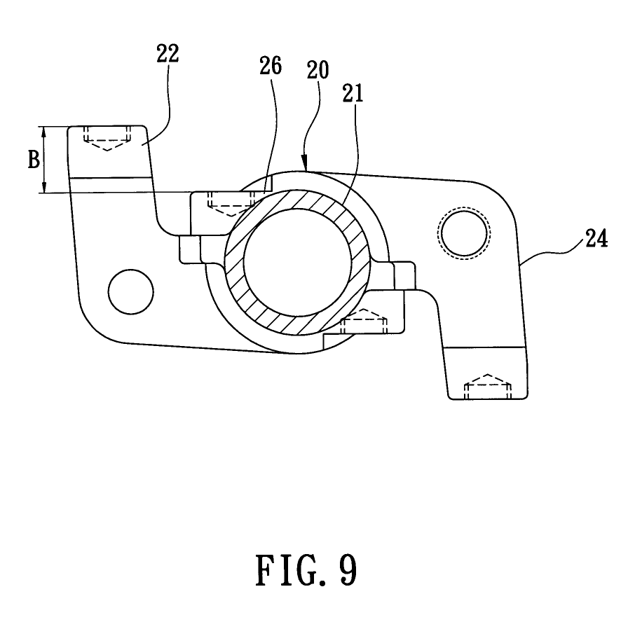

Referring to FIGS. 4, 5, 8, and 9, the pedal body 20 is unitary, is made of an aluminum alloy or a magnesium alloy so as to have the advantages of lightweight and reducing the manufacturing costs, and includes a shaft tube 21 sleeved rotatably on the pedal shaft 10 and rotatable about the axis (A), two aligned front wings 22, 23 extending frontwardly from the shaft tube 21, two rear wings 24, 25 extending rearwardly from the shaft tube 21, two internally threaded rear posts 26, two internally threaded front posts 27, and a stop element 28 (see FIG. 5) formed between the shaft tube 21 and the right rear wing 24. Each of the front posts 27 extends upwardly from a front end of the corresponding front wing 22, 23. Each of the rear posts 26 extends upwardly from a junction between the shaft tube 21 and the corresponding front wing 22, 23. Each of the front and rear posts 27, 26 has an upper end surface that is formed with a threaded hole 270, 260 (see FIG. 8). Upper ends of the front posts 27 are disposed above and are spaced apart from those of the rear posts 26 by a distance (B) along a vertical direction, as shown in FIG. 9.

The cleat-retaining mechanism includes a front cleat-retaining member 70, a rear cleat-retaining member 30, a biasing member 40, an adjusting unit 50, and an indicating unit 60.

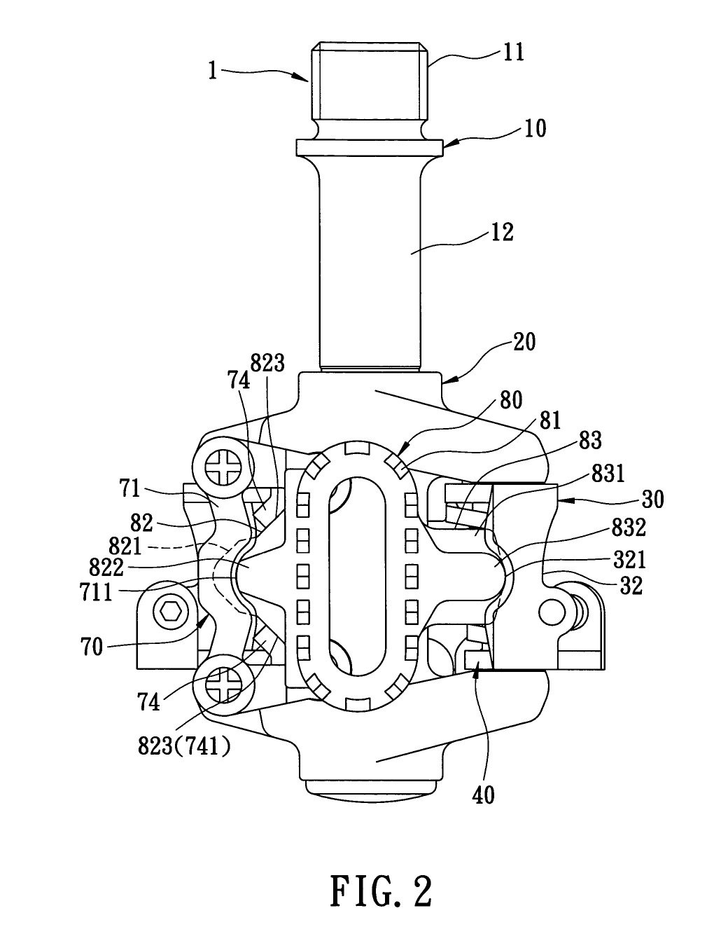

Referring to FIGS. 2, 3, 4, 5, and 6, the front cleat-retaining member 70 is disposed in front of the shaft tube 21 and between the front wings 22, 23, is unitary, and includes a middle portion 71, two front fixing portions 72, two rear fixing portions 73, and two side portions 74. Each of the middle portion 71, the side portions 74, and the front and rear fixing portions 72, 73 is shaped as a rod. The middle portion 71 has two opposite ends connected respectively to the front fixing portions 72, and a curved front cleat-limiting surface 711 that faces the shaft tube 21. The front fixing portions 72 have top surfaces that are formed respectively with two counterbores (72H) (see FIG. 4). The rear fixing portions 73 extend respectively and rearwardly from the front fixing portions 72, and have top surfaces that are formed respectively with two counterbores (73H) (see FIG. 4). The side portions 74 extend respectively, inwardly, and frontwardly from the front fixing portions 72, are disposed slightly above the rear fixing portions 73, and are formed respectively with two inclined cleat-guiding surfaces 741, between which the curved front cleat-limiting surface 711 is disposed. As such, a limiting groove (G) is defined under the middle portion 71 and between the side portions 74. The inclined cleat-guiding surfaces 741 face the shaft tube 21, and are disposed below the curved front cleat-limiting surface 711. Two headed front bolts 75 extend respectively through the counterbores (72H) in the front fixing portions 72, and engage respectively the threaded holes (270) (see FIG. 8) in the front posts 27. Two headed rear bolts 76 extend respectively through the counterbores (73H) in the rear fixing portions 73, and engage respectively the threaded holes (260) (see FIG. 8) in the rear posts 26.

Because the front fixing portions 72 have the same thickness as the rear fixing portions 73, top surfaces of the former are disposed above and are spaced apart from those of the latter by the distance (B) (see FIG. 9) along the vertical direction. As such, the cleat 80 can be supported by the rear fixing portions 73.

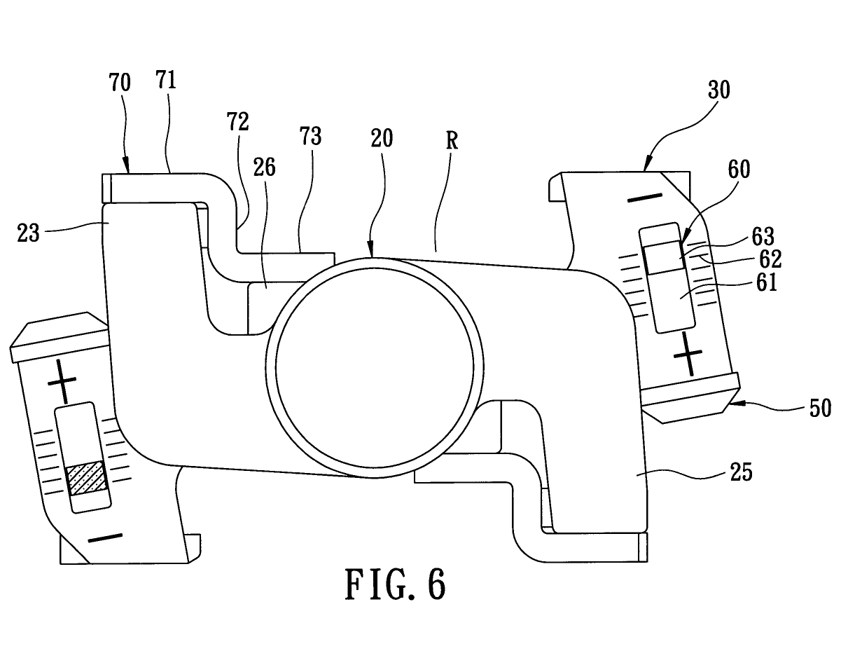

The rear cleat-retaining member 30 is disposed between and is connected rotatably to the rear wings 24, 25 by a horizontal pivot 39. A cleat-retaining space (R) (see FIG. 6) is defined among the front and rear cleat-retaining members 70, 30 and the shaft tube 21. The rear cleat-retaining member 30 is unitary, and has a top wall 32, an upright inner side wall 33 extending downwardly from an inner side of the top wall 32, an upright outer side wall 34 extending downwardly from an outer side of the top wall 32, an inner pivot hole 35 formed through the inner side wall 33, a frontwardly extending projection 351 formed on the inner side wall 33, an outer pivot hole 36 formed through the outer side wall 34, and a bottom wall 37 extending inwardly from a lower end of the outer side wall 34. The top wall 32 has a curved rear cleat-limiting surface 321. The horizontal pivot 39 extends through the inner and outer pivot holes 35, 36 and into the rear wings 24, 25.

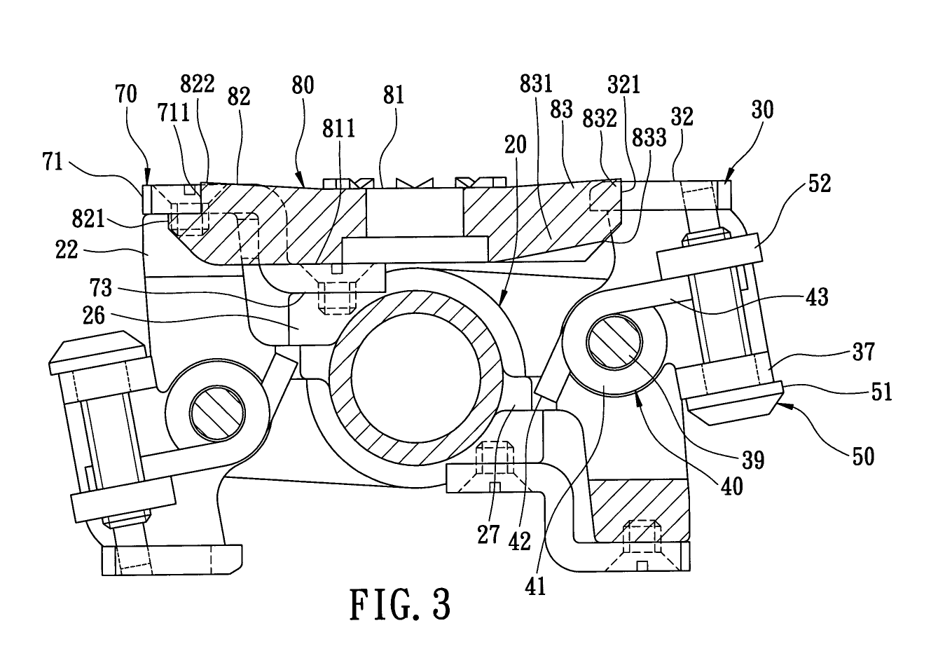

Referring to FIGS. 2 and 3, the cleat 80 is unitary, is confined within the cleat-retaining space (R) (see FIG. 6), and has a front end engaging portion 82 that engages the front cleat-retaining member 70 and that is retained between the front cleat-retaining member 70 and the shaft tube 21, and a rear end engaging portion 83 that engages the rear cleat-retaining member 30 and that is retained between the rear cleat-retaining member 30 and the shaft tube 21. The front end engaging portion 82 has a wide lower portion 821 and a narrow upper portion 822. The wide lower portion 821 is inserted into the limiting groove (G) in the front cleat-retaining member 70 at a front end thereof, and has two rearwardly and outwardly inclined side surfaces 823 abutting respectively against the inclined cleat-guiding surfaces 741 (see FIG. 5) of the front cleat-retaining member 70 so as to confine the wide lower portion 821 between the inclined cleat-guiding surfaces 741 (see FIG. 5). The narrow upper portion 822 is formed on an intermediate portion of the wide lower portion 821, and abuts against the front cleat-limiting surface 711 of the front cleat-retaining member 70 at a front end thereof. The rear end engaging portion 83 of the cleat 80 also has a wide lower portion 831 and a narrow upper portion 832 formed on a middle portion of the wide lower portion 831. The wide lower portion 831 has a rear end inserted into a space defined among the top wall 32, the inner side wall 33, and the outer side wall 34 of the rear cleat-retaining member 30, and is formed with an inclined rear end surface 833 that is inclined rearwardly and upwardly. The narrow upper portion 832 has a rear end abutting against the curved cleat-limiting surface 321 of the rear cleat-retaining member 30.

Referring to FIGS. 3, 4, and 5, the biasing member 40 is configured as a coiled torsional spring, and has a coiled body 41 disposed around the pivot 39, an inner end 42 pressing against a bottom surface of the stop element 28, and an outer end 43 biasing the rear cleat-retaining member 30 to turn frontwardly to a position, where the projection 351 of the rear cleat-retaining member 30 presses against the stop element 28 so as to prevent further rotation of the rear cleat-retaining member 30 and where the curved rear cleat-limiting surface 321 of the rear cleat-retaining member 30 presses against the top surface of the wide lower portion 831 of the rear end engaging portion 83 of the cleat 80 so as to clamp and fix the cleat 80 between the rear cleat-retaining member 30 and the pedal body 20. The narrow upper portion 832 of the rear end engaging portion 83 of the cleat 80 has a rear end that is confined within a gap 322 (see FIG. 5), which is defined by the curved rear cleat-limiting surface 321 of the rear cleat-retaining member 30.

The adjusting unit 50 includes an adjustment bolt 51 extending through a hole 371 (see FIG. 5) in the bottom wall 37 of the rear cleat-retaining member 30 and into a hole 323 in the top wall 32 of the rear cleat-retaining member 30, and an adjustment nut 52 engaging the adjustment bolt 51 and located between the bottom wall 37 and the top wall 32. The outer end 43 of the biasing member 40 is disposed between the adjustment nut 52 and the bottom wall 37 of the rear cleat-retaining member 30, and presses against the adjustment nut 52. The adjustment bolt 51 has a head 511 that is formed with a plurality of angularly equidistant projections 53, as shown in FIG. 5. The bottom wall 37 of the rear cleat-retaining member 30 is formed with a plurality of radially extending grooves (not shown) that engage respectively the projections 53 of the adjustment bolt 51 so as to permit indexing rotation of the adjustment bolt 51 when the biasing force of the biasing member 40 is adjusted.

The indicating unit 60 includes a slide slot 61 formed through the outer side wall 34 of the rear cleat-retaining member 30, a scale 62 disposed on the outer side wall 34 near the slide slot 61, and an indicating element 63 formed integrally with the adjustment nut 52 and received slidably in the slide slot 61 so as to prevent rotation of the adjustment nut 52 relative to the rear cleat-retaining member 30 and so as to permit movement of the adjustment nut 52 relative to the rear cleat-retaining member 30 during adjustment of the adjustment bolt 51.

Referring to FIGS. 1 and 2, during assembly, the cleat 80 is secured to the cyclist's shoe 90. The wide lower portion 821 of the front end engaging portion 82 of the cleat 80 is inserted into the groove (G) (see FIGS. 4 and 5) in the front cleat-retaining member 70. The rear end engaging portion 83 of the cleat 80 is placed over the rear cleat-retaining member 30. A downward force is applied to the rear end engaging portion 83 of the cleat 80 such that the inclined rear end surface 833 of the wide lower portion 831 of the rear end engaging portion 83 of the cleat 80 slides on the rear cleat-retaining member 30. As such, the rear cleat-retaining member 30 can be turned rearwardly so as to permit the cleat 80 to be clamped between the rear cleat-retaining member 30 and the pedal body 20.

When it is desired to remove the shoe 90 from the front and rear cleat-retaining members 70, 30, the cleat 80 is swung forcibly in a horizontal plane to move the inclined side surfaces 823 of the wide lower portion 821 of the front end engaging portion 82 of the cleat 80 over the inclined cleat-guiding surfaces 741 of the front cleat-retaining member 70 so as to turn the rear cleat-retaining member 30 rearwardly, thereby permitting removal of the cleat 80 from the front cleat-retaining member 70. Then, the cleat 80 is removed from the shoe 90.

With this invention thus explained, it is apparent that numerous modifications and variations can be made without departing the scope and spirit of this invention. It is therefore intended that this invention be limited only as indicated by the appended claims.

1. A bicycle pedal assembly comprising:
a pedal shaft;
a unitary pedal body including a shaft tube sleeved rotatably on said pedal shaft, two aligned front wings extending frontwardly from said shaft tube, and two aligned rear wings extending rearwardly from said shaft tube;
a front cleat-retaining member disposed in front of said shaft tube and between said front wings and having
a middle portion with a curved front cleat-limiting surface facing said shaft tube,
two side portions formed respectively with two rearwardly and outwardly inclined cleat-guiding surfaces that face said shaft tube, that are disposed below said front cleat-limiting surface, and that are located at two sides of said front cleat-limiting surface,
a limiting groove disposed under said middle portion and between said side portions,
two front fixing portions connected respectively and threadedly to said front wings, and
two rear fixing portions connected threadedly to an assembly of said shaft tube and said front wings and located behind said front fixing portions;
a rear cleat-retaining member mounted pivotally between said rear wings so as to define a cleat-retaining space among said front and rear cleat-retaining members and said shaft tube;
a unitary cleat confined within said cleat-retaining space and having a front end engaging portion that engages said front cleat-retaining member and that is retained between said front cleat-retaining member and said shaft tube, and a rear end engaging portion that engages said rear cleat-retaining member and that is retained between said rear cleat-retaining member and said shaft tube, said front end engaging portion having a wide lower portion that is inserted into said limiting groove in said front cleat-retaining member at a front end thereof and that has two rearwardly and outwardly inclined side surfaces abutting respectively against said inclined cleat-guiding surfaces of said side portions of said front cleat-retaining member, and a narrow upper portion formed on an intermediate portion of said wide lower portion and abutting against said curved front cleat-limiting surface of said front cleat-retaining member at a front end thereof; and
a biasing member for biasing said rear cleat-retaining member to turn frontwardly so as to clamp and fix said cleat between said rear cleat-retaining member and said pedal body, said cleat being swingable forcibly in a horizontal plane to move said inclined side surfaces of said front end engaging portion of said cleat along said inclined cleat-guiding surfaces of said front cleat-retaining member so as to permit removal of said cleat from said front cleat-retaining member.

2. The bicycle pedal assembly as claimed in claim 1, wherein said front cleat-retaining member is unitary, each of said middle portion, said side portions, and said front and rear fixing portions of said front cleat-retaining member being shaped as a rod, said middle portion having two opposite ends that are connected respectively to said front fixing portions, said rear fixing portions extending respectively and rearwardly from said front fixing portions, said side portions extending respectively, inwardly, and frontwardly from said front fixing portions.

3. The bicycle pedal assembly as claimed in claim 2, wherein said pedal body further includes two internally threaded front posts, each of which extends integrally and upwardly from a front end of a corresponding one of said front wings and is formed with a threaded hole at an upper end surface thereof, and two internally threaded rear posts, each of which extends integrally and upwardly from a junction between said shaft tube and the corresponding one of said front wings and is formed with a threaded hole in an upper end surface thereof, each of said front and rear fixing portions of said front cleat-retaining member having a top surface that is formed with a counterbore, said front cleat-retaining member further having two headed front bolts, each of which extends through a respective one of said counterbores in said front fixing portions of said front cleat-retaining member and engages a respective one of said threaded holes in said front posts of said pedal body, and two headed rear bolts, each of which extends through a respective one of said counterbores in said rear fixing portions of said front cleat-retaining member and engages a respective one of said threaded holes in said rear posts of said pedal body.

4. The bicycle pedal assembly as claimed in claim 3, wherein said top surfaces of said rear fixing portions of said front cleat-retaining member are disposed below and are spaced apart from said top surfaces of said front fixing portions of said front cleat-retaining member by a predetermined distance, and support said cleat thereon.

5. The bicycle pedal assembly as claimed in claim 1, wherein said pedal body is made of an aluminum alloy.

6. The bicycle pedal assembly as claimed in claim 1, wherein said pedal body is made of a magnesium alloy.

7. The bicycle pedal assembly as claimed in claim 1, wherein said rear cleat-retaining member includes:
a top wall having an inner side, an outer side, and a curved rear cleat-limiting surface disposed between said inner and outer sides;
an upright inner side wall extending integrally and downwardly from said inner side of said top wall and formed with a frontwardly extending projection and an inner pivot hole;
an upright outer side wall extending integrally and downwardly from said outer side of said top wall and formed with an outer pivot hole;
a bottom wall extending inwardly from a lower end of said outer side wall; and
a horizontal pivot extending through said inner pivot hole in said inner side wall and said outer pivot hole in said outer side wall and into said rear wings;
said bicycle pedal assembly further including an adjusting unit that includes:
an adjustment bolt extending through said bottom wall of said rear cleat-retaining member; and
an adjustment nut engaging said adjustment bolt and located between said bottom wall and said top wall;
said biasing member being configured as a coiled torsional spring that has an inner end pressing against said shaft tube, and an outer end disposed between said adjustment nut and said bottom wall of said rear cleat-retaining member and pressing against said adjustment nut so as to press said projection of said rear cleat-retaining member against said pedal body.

8. The bicycle pedal assembly as claimed in claim 7, wherein said outer side wall of said rear cleat-retaining member is formed with a slide slot therethrough, said bicycle pedal assembly further including:
a scale disposed on said outer side wall near said slide slot; and
an indicating element formed integrally with said adjustment nut and received slidably in said slide slot so as to prevent rotation of said adjustment nut relative to said rear cleat-retaining member and so as to permit movement of said adjustment nut relative to said rear cleat-retaining member during adjustment of said adjustment bolt.
